(19) United States
(12) Patent Application Publication
(10) Pub. No.: US 2025/0342677 A1
(43) Pub. Date: Nov. 6, 2025

(54) REMOTE SENSING LANDSLIDE OBJECT DETECTION MODEL, METHOD, SYSTEM AND READABLE MEDIUM

(71) Applicant: Hefei University of Technology, Hefei (CN)

(72) Inventors: Chunju Zhang, Hefei (CN); Xiangyu Zhao, Hefei (CN); Peng Ye, Hefei (CN); Jianwei Huang, Hefei (CN); Yifan Pei, Hefei (CN); Chenxi Li, Hefei (CN); Kai Liu, Hefei (CN)

(73) Assignee: Hefei University of Technology, Hefei, AH (CN)

(21) Appl. No.: 19/266,164

(22) Filed: Jul. 11, 2025

(30) Foreign Application Priority Data
Aug. 22, 2024 (CN) 202411158565.2

(51) Int. Cl. G06V 10/25; G06T 7/10; G06V 20/17; G06V 20/70

(52) U.S. Cl. CPC G06V 10/25; G06T 7/10; G06V 20/17; G06V 20/70; G06V 2201/07

(57) ABSTRACT

The present invention relates to the field of remote sensing image object detection technology, particularly a remote sensing landslide object detection model, a method, a system and a readable medium. The remote sensing landslide object detection model provided by the present invention, firstly, the model pre-trains the embedding module, the location encoding module, and the attention feature extraction module on the first training set to realize the learning of the knowledge attributes associated with the auxiliary images; and then the attention feature extraction module and the Mask-RCNN model are further trained on the complete data set, so as to realize the fusion of the knowledge features and the visible image features, and comprehensively describe the characteristics of landslides, and the deep learning model is adopted to automatically extract the complex features to improve the detection capability of the landslide area.

### TECHNICAL FIELD

The present invention relates to the field of remote sensing image object detection technology, particularly a remote sensing landslide object detection model, a method, a system and a readable medium.

### BACKGROUND

Remote sensing landslide object detection is defined as the process of automatic identification and localization of landslide areas on the surface of the Earth with remote sensing technology. A landslide is a displacement phenomenon of soil or rock along a slope due to geological and climatic factors, which frequently causes serious natural disasters. The image data obtained by remote sensing can be used to analyze landslide areas, so as to rapidly and accurately detect the location and scale of landslides and provide support for disaster management and emergency response.

Although remote sensing landslide object detection technology plays an important role in disaster monitoring, there are still some deficiencies and challenges: 1. The environment where landslides occur is typically complex and variable, including different geologic conditions, vegetation cover, and meteorological changes. The detection of landslide is difficult as these factors affect the quality and information extraction of remote sensing images. For example, landslide features may be obscured by densely vegetated areas, which can affect detection accuracy. 2. All the potential information in remote sensing data is not fully used during the process of landslide detection; in some cases, the detection work relies only on a single type of remote sensing data, or the data fusion and feature extraction process may not be comprehensive enough, resulting in a failure to extract useful information.

### SUMMARY

In order to overcome the defects of remote sensing landslide object detection that cannot fully extract useful information and has low detection accuracy in the above-mentioned existing technology, the present invention proposes a training method for a remote sensing landslide object detection model, and the trained remote sensing landslide object detection model can fully extract the potential information through the fusion of auxiliary images and visible light images, which greatly improves the accuracy of landslide detection.

The present invention proposes a training method for a remote sensing landslide object detection model, including the following steps:
S1, constructing a data set to store landslide samples {(a visible light image, an auxiliary image); (a mask image, a bounding box)}, and the auxiliary image is a grayscale image of an associated attribute feature; both the visible light image and the grayscale image are shooting images of a detection area; the mask image is used to annotate a landslide area in the visible light image; the bounding box is used to annotate landslide area in the visible light image;
S2, constructing a knowledge embedding model, the knowledge embedding model includes an embedding module, an attention feature extraction module, a location encoding module, and a segmentation head that are connected in sequence; and the knowledge embedding model takes the auxiliary image as an input and the mask image as an output;
S3, extracting a first training set {auxiliary image, mask image} from the data set, and training the knowledge embedding model on the first training set until convergence;
S4, extracting the sequentially connected embedding module, the attention feature extraction module, the location encoding module from the knowledge embedding model, and connecting the location coding module to a Mask-Region Convolution Neural Networks (Mask-RCNN) model through a convolution module to form a basic model; input data of the basic model includes the visible light image and the auxiliary image, and an output is the visible light image annotated with bounding box and mask image; and
S5, training the basic model in the data set {(visible light image, auxiliary image); (mask image, bounding box)} to update the attention feature extraction module, the convolution module and the Mask-RCNN model until the basic model converges; the converged basic model is the remote sensing landslide object detection model.

Preferably, the attribute features include one or more of elevation, slope, aspect, plane curvature, profile curvature, vegetation coverage, annual rainfall, flow intensity index and topographic humidity index.

Preferably, the basic model is trained on the data set, and a loss function used in the training process is: a sum of a classification loss, a bounding box regression loss, and a mask segmentation loss.

Preferably, the calculation formula of classification loss Loss_{cls} is:

$${Loss}_{cls} = - {\sum }_{i = 1}^{N} {y}_{i} log ( {p}_{i} )$$

where yᵢ is a real class label, yᵢ=1 denotes that the landslide is detected, yᵢ=0 denotes that no landslide is detected; pᵢ denotes a landslide probability predicted by the basic model; N is a number of classes, the classes include landslide and non-landslide.

Preferably, the calculation formula of bounding box regression loss Loss_{box} is:

$${Loss}_{box} = \frac{1}{M} {\sum }_{m = 1}^{M} {\sum }_{n ∈ \{ x , y , {w}^{′} , {h}^{′} \}} SmoothL 1 ( {t}_{mn} - {t}_{mn}^{′} )$$

$$SmoothL 1 ( x ) = \{ \begin{matrix}0.5 {x}^{′2} & if \vert {x}^{′} \vert < 1 \\ \vert {x}^{′} \vert - 0.5 & otherwise\end{matrix}$$

where M is a number of anchor boxes of landslide samples; tₘₙ denotes a basic model prediction value of a regression objective n of an m^{th} landslide sample anchor box, the regression objective includes an anchor box center coordinate (x, y), an anchor box width w′ and an anchor box height h′, t′ denotes a true value of the regression objective n of the m^{th} landslide sample anchor box; (tₘₙ−t′ₘₙ) denotes an error of tₘₙ and t′ₘₙ, smoothL1 is a choose function; x′ is a referential parameter.

Preferably, the calculation formula of mask segmentation loss Lossₘₐₛₖ is:

$${Loss}_{mask} = - \frac{1}{H \times W} {\sum }_{h = 1}^{H} {\sum }_{w = 1}^{W} [ {y}_{h , w} ln ( {p}_{h , w} ) + ( 1 - {y}_{h , w} ) ln ( 1 - {p}_{h , w} ) ]$$

where H is a height of the visible light image, W is a width of the visible light image, y_{h,w} denotes a value of pixel coordinates (h, w) on a corresponding visible light image on the real mask image; p_{h,w} denotes a probability that the value of the pixel coordinate (h, w) on the mask image predicted by the basic model is 1; ln denotes a logarithmic function.

Preferably, the embedding module adopts a query dictionary embedding; the location coding module adopts a rotary coding method, and the attention feature extraction module adopts a convolutional block attention module (CBAM).

The present invention proposes a remote sensing landslide object detection method, including:
St1, obtaining a remote sensing landslide object detection model; acquiring a visible light image and an auxiliary image of the detection area;
St2, inputting the visible light image and the auxiliary image into the remote sensing landslide object detection model, wherein the remote sensing landslide object detection model outputs the visible light image that are annotated with the bounding box and the mask image.

A remote sensing landslide object detection system provided by the present invention, the system includes an unmanned aerial vehicle (UAV), a memory, and a processor, wherein the UAV is used to collect visible light images and auxiliary images; the memory stores a computer program, and the processor is connected to the memory and the UAV, and the processor is configured to execute the computer program to implement the remote sensing landslide object detection method.

A readable medium provided by the present invention, the readable medium stores a computer program, and when the computer program is executed, the computer program is used to implement the remote sensing landslide object detection method.

The advantages of the present invention are:

(1) The training method for the remote sensing landslide object detection model provided by the present invention constructs a knowledge feature extractor including the embedding module, the location encoding module, and the attention feature extraction module, which fully analyzes the potential features of the auxiliary image, and effectively improves the accuracy of the remote sensing landslide object detection and the efficiency of the utilization of the multivariate data.

(2) The remote sensing landslide object detection model provided by the present invention, firstly, the model pre-trains the embedding module, the location encoding module and the attention feature extraction module on the first training set to realize the learning of the knowledge attributes associated with the auxiliary images; and then the attention feature extraction module and the Mask-RCNN model are further trained on the complete data set, so as to realize the fusion of the knowledge features and the visible image features, so as to combine the knowledge features and image features to comprehensively describe the characteristics of landslides, and the deep learning model is adopted to automatically extract the complex features to improve the detection capability of the landslide area.

(3) The remote sensing landslide object detection method provided by the present invention adopts the above mentioned remote sensing landslide object detection model and performs object detection under the support of multi-dimensional data, which improves the data utilization rate and detection accuracy.

(4) The remote sensing landslide object detection system and readable medium provided by the present invention provide a carrier for the remote sensing landslide object detection model and method.

### BRIEF DESCRIPTION OF THE DRAWINGS

FIG. 1 is a flow chart of a training method for a remote sensing landslide object detection model;

FIG. 2 is a structural diagram of a knowledge embedding model;

FIG. 3 is a structural diagram of a remote sensing landslide object detection model;

FIG. 4 is a topological diagram of a remote sensing landslide object detection model;

FIG. 5 is a comparison of a mean pixel accuracy of two models in the embodiment;

FIG. 6 is a detection result of a Knowledge Graph Embedding (KGE)-Mask-RCNN model.

### DETAILED DESCRIPTION OF THE EMBODIMENTS

The following clearly and completely describes the technical solutions in embodiments of the present invention with reference to the drawings of embodiments of the present invention. Apparently, the described embodiments are only some but not all of the embodiments of the present invention. All other embodiments obtained by those of ordinary skill in the art based on the embodiments of the present invention without involving any creative effort shall fall within the scope of protection of the present invention.

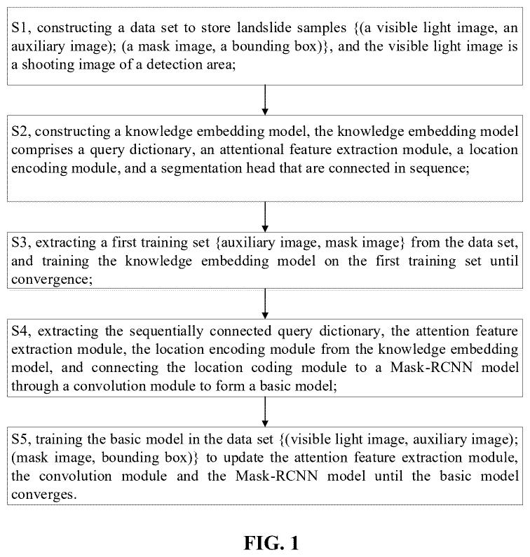

With reference to FIG. 1, the embodiment of a training method for a remote sensing landslide object detection model, including the following steps:

S1, the data set is constructed to store landslide samples {(the visible light image, the auxiliary image); (the mask image, the bounding box)}, the visible light image is the shooting image of the detection area; the auxiliary image is the grayscale image of the associated attribute feature, the attribute features include elevation, slope, aspect, plane curvature, profile curvature, vegetation coverage, annual rainfall, flow intensity index and topographic humidity index; the mask image is used to annotate the landslide area in the visible light image; the bounding box adopts the record way of the Extensible Markup Language (XML) file; and the bounding box is used to annotate landslide area in the visible light image.

The grayscale image of elevation and vegetation coverage is associated and collected by UAV remote sensing, that is, the UAV shoots the image and annotates the elevation and vegetation coverage;
the annual rainfall is obtained by data statistics, and the global precipitation measurement (GPM) data of the National Aeronautics and Space Administration (NASA) can be downloaded directly;
slope, aspect, plane curvature and profile curvature can be calculated by combining elevation and vegetation coverage;
the flow intensity index and topographic humidity index are obtained by combining elevation, vegetation coverage and annual rainfall.

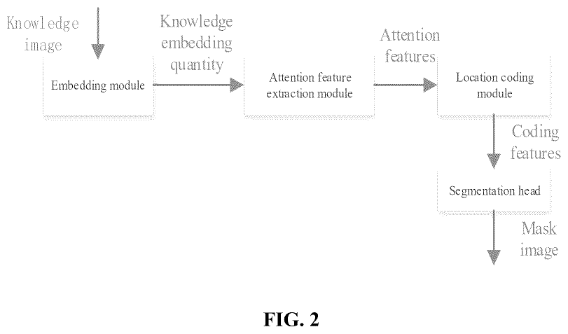

The visible light image is obtained by UAV photogrammetry.
S2, the knowledge embedding model shown in FIG. 2 is constructed, the knowledge embedding model includes the embedding module, the attention feature extraction module, the location encoding module and the segmentation head that are connected in sequence; and the knowledge embedding model takes the auxiliary image as the input and the mask image as the output;
the embedding module is used to convert the auxiliary image into a knowledge embedding vector, the attention feature extraction module is used to extract the attention features of the knowledge embedding vector, and then passed to the location coding module for feature coding, the mask image is generated by the segmentation head based on feature coding.

Specifically, the embedding module can be embedded in a query dictionary to map the low-dimensional auxiliary image to a high-dimensional space to form the knowledge embedding vector. In this embodiment, the embedding module establishes a dictionary for each knowledge; in the embedding module, the vocabulary size of the query dictionary is set to 64, and the embedding dimension is 4, then each pixel is mapped to a 4N-dimensional vector by query, and N is the number of attribute features; then the 4N channel feature map of the auxiliary image is formed by pixel splicing.

The location coding module adopts the rotary coding method, and the attention feature extraction module adopts the CBAM; the segmentation head is composed of four convolution layers connected sequentially, and the number of convolution kernels is set to 64, 512, 32 and 2 respectively, the size of convolution kernels is 7×7, 3×3, 3×3 and 1×1 respectively, the step size is 1, and the filling distance is 3, 1, 1 and 0 respectively.

S3, the first training set {the auxiliary image, the mask image} is extracted from the data set, and the knowledge embedding model is trained on the first training set until convergence.

The convergence conditions of the knowledge embedding model can be set as follows: the number of training times reaches the set value, the model accuracy converges, the model loss converges, etc.

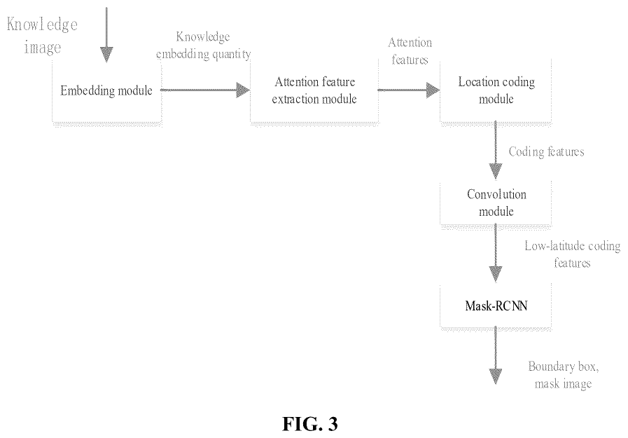

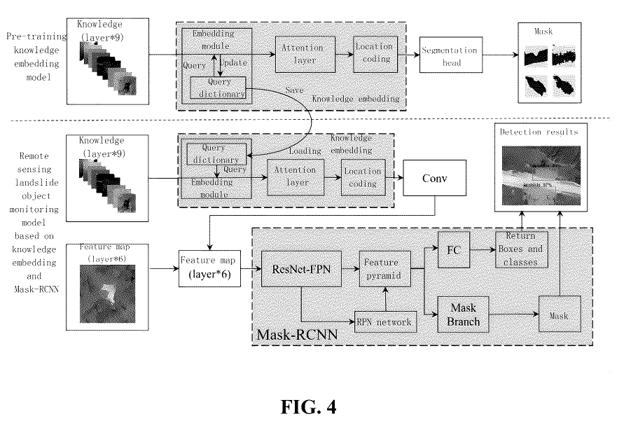

S4, the sequentially connected embedding module, the attention feature extraction module, the location encoding module are extracted from the knowledge embedding model, and the location coding module is connected to the Mask-RCNN model through the convolution module to form the basic model as shown in FIGS. 3-4; the input data of the basic model includes the visible light image and the auxiliary image, and the output is the visible light image annotated with the bounding box and mask image; the auxiliary image is processed into coding features by the embedding module, the attention feature extraction module and the location coding module, the coding features are convoluted by the convolution module and spliced with the visible light image, and then input into the Mask-RCNN model for processing, and the Mask-RCNN model outputs the bounding box and mask images that annotate the landslide area.

That is, the input of the basic model is connected to the input of the embedding module and the input of the Mask-RCNN model respectively, and the output of the basic model is the output of the Mask-RCNN model.

In the basic model, the visible light image typically includes three channels of R, G and B, the 4N-dimensional coding features output by the coding features adjust the number of channels through the convolution model to avoid the weight deviation between the number of coding features channels and the number of visible light channels.

S5, the basic model is trained in the data set {(the visible light image, the auxiliary image); (mask image, bounding box)} to update the attention feature extraction module, the convolution module and the Mask-RCNN model until the basic model converges; the converged basic model is the remote sensing landslide object detection model.

The training process of the basic model includes the following steps:
S51, the data set is divided into a training set and a validation set;
S52, training samples are extracted from the training set {(visible light image, auxiliary image); (mask image, bounding box)}, so that the basic model learns the training samples, and updates the attention feature extraction module, convolution module and Mask-RCNN model;
S53, test samples are extracted from the training set {(visible light image, auxiliary image); (mask image, bounding box)}, the basic model predicts the bounding box and the mask image based on the visible light image and the auxiliary image, and the model loss Loss is calculated based on the true value and the predicted value of the bounding box and the mask image; the attention feature extraction module, convolution module and Mask-RCNN model in the basic model are iterated through the model loss reverse transfer;

$$Loss = {Loss}_{box} + {Loss}_{mask} + {Loss}_{cls}$$

where Loss_{cls}, Loss_{box}, and Lossₘₐₛₖ denote classification loss, bounding box regression loss, and mask segmentation loss, respectively, are calculated as follows:

$${Loss}_{cls} = - {\sum }_{i = I}^{N} {y}_{i} \cdot log ( {p}_{i} )$$

where yᵢ is the real class label, yᵢ=1 denotes that the landslide is detected, yᵢ=0 denotes that no landslide is detected; pᵢ denotes the landslide probability predicted by the basic model; N=2 denotes classes, that is, landslide and non-landslide;

$${Loss}_{box} = \frac{1}{M} {\sum }_{m = 1}^{M} {\sum }_{n ∈ \{ x , y , {w}^{′} , {h}^{′} \}} SmoothL 1 ( {t}_{mn} - {t}_{mn}^{′} )$$

$$SmoothL 1 ( x ) = \{ \begin{matrix}0.5 {x}^{′2} & if \vert {x}^{′} \vert < 1 \\ \vert {x}^{′} \vert - 0.5 & otherwise\end{matrix}$$

where M is the number of anchor boxes of landslide samples; tₘₙ denotes the basic model prediction value of the regression objective n of the m^{th} landslide sample anchor box, the regression objective includes the anchor box center coordinate (x, y), the anchor box width w′ and the anchor box height h′, x is the abscissa of the center of the anchor box on the image, y is the ordinate of the center of the anchor box on the image; t′ denotes the true value of the regression objective n of the m^{th} landslide sample anchor box; (tₘₙ−t′ₘₙ) denotes the error of tₘₙ and t′ₘₙ; smoothL1 is the choose function; x′ is the referential parameter; the anchor box is a preset size, traversing each pixel to take all the pixel frames that contain the landslide object as much as possible.

$${Loss}_{mask} = - \frac{1}{H \times W} {\sum }_{h = 1}^{H} {\sum }_{w = 1}^{W} [ {y}_{h , w} ln ( {p}_{h , w} ) + ( 1 - {y}_{h , w} ) ln ( 1 - {p}_{h , w} ) ]$$

where H is the height of the visible light image, W is the width of the visible light image, y_{h,w} denotes the value of the pixel coordinates (h, w) on the corresponding visible light image on the real mask image; y_{h,w}=0 indicates that the pixel coordinates (h, w) are not in the landslide area, y_{h,w}=1 indicates that the pixel coordinates (h, w) are in the landslide area, p_{h,w} denotes the probability that the value of the pixel coordinate (h, w) on the mask image predicted by the basic model is 1.
S54, whether the number of model iterations reaches a set threshold is determined; if it is not, then return to step S52; if it is, then execute step S55;
S55, the performance index of the basic model is calculated on the validation set, and it is determined whether the performance index has reached convergence; if it is not, then return to step S51 and the number of iterations of the basic model is recounted; if it is, then the basic model is fixed and the training is finished.

The embodiment proposes a remote sensing landslide object detection method, including the following steps:
St1, the remote sensing landslide object detection model is obtained; the visible light image and the auxiliary image of the detection area are acquired;
the visible light images are shot by the UAV;
the auxiliary image acquisition method is as follows: firstly, the UAV patrol is used to obtain the image of the annotated elevation and vegetation coverage of the detection area; secondly, the GPM data set of NASA is combined, the annual rainfall is annotated on the image, and the aspect, plane curvature, profile curvature, water flow intensity index and topographic humidity index are calculated by combining elevation, vegetation coverage and annual rainfall, so as to obtain the grayscale image with elevation, vegetation coverage, annual rainfall, calculated aspect, plane curvature, profile curvature, water flow intensity index and topographic humidity index as the auxiliary image;
St2, the visible light image and the auxiliary image are input into the remote sensing landslide object detection model, and the auxiliary image is processed into the coding feature through the embedding module, the attention feature extraction module and the location coding module in turn, the coding features are convoluted by the convolution module and input into the Mask-RCNN model together with the visible light image for processing, and the Mask-RCNN model outputs the bounding box and mask images that annotate the landslide area.

The following is a description of the above-described remote sensing landslide object detection model in conjunction with specific embodiments.

In this embodiment, firstly, the data set {(visible image, auxiliary image); (mask image, bounding box)} is constructed based on the known landslide samples, and the data set is divided into the training set and the validation set.

In this embodiment, firstly, samples {auxiliary images, mask images} are extracted from the data set to train the knowledge embedding model until the number of training times reaches 25; secondly, the remote sensing landslide object detection model is trained on the training set, and recorded as KGE-Mask-RCNN.

In this embodiment, the training set is also used to directly train the Mask-RCNN model as a comparison model.

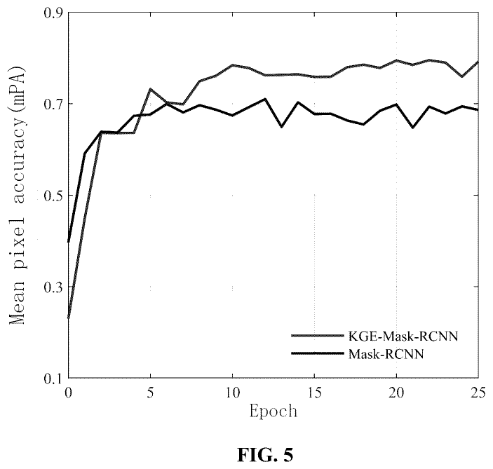

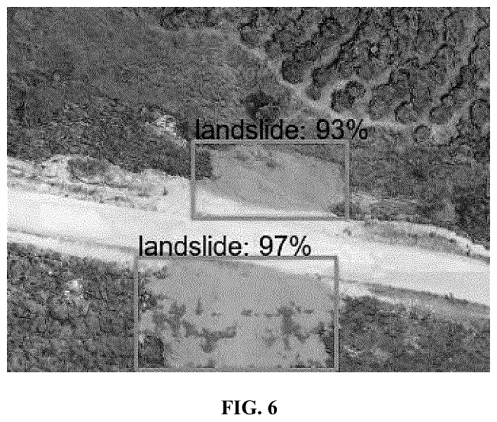

In this embodiment, the mean pixel accuracy (mPA) of the KGE-Mask-RCNN model and the Mask-RCNN model is verified on the validation set, and as the number of epochs on the training set increases, the mPA is shown in FIG. 5. It can be seen that the mean accuracy of the Mask-RCNN model converges around 0.7, while the mean accuracy of the KGE-Mask-RCNN model converges around 0.8; it proves that the KGE-Mask-RCNN model has greatly improved the accuracy of landslide detection. After the trained KGE-Mask-RCNN model processes a sample {visible image, auxiliary image} in the validation set, the output of the landslide bounding box from the KGE-Mask-RCNN model is shown in FIG. 6, which shows that the annotated results are very clear and precise, and the two landslide areas on the landslide image are annotated, and the confidence level of the recognition results reaches 93% and 97%, respectively.

Certainly, for those skilled in the art, the present invention is not limited to the details of the above-described exemplary embodiments, but also includes the same or similar structures that can be realized in other specific forms without departing from the spirit or basic features of the present invention. Accordingly, the embodiments are to be regarded as exemplary and non-limiting in every respect, and the scope of the present invention is limited by the appended claims and not by the foregoing description, so that all variations falling within the meaning and scope of the equivalent elements of the claims are intended to be encompassed within the present invention. Any accompanying annotatings in the drawings of the claims should not be regarded as limiting the claims to which they relate.

Additionally, it should be understood that although the specification is described in accordance with the embodiments, not each embodiment contains only one independent technical solution, and the specification is described in such a manner only for the sake of clarity, and those skilled in the art should take the specification as a whole, and the technical solutions in each embodiment may be combined appropriately to form other embodiments that can be understood by those skilled in the art. The techniques, shapes, and construction parts not described in detail in the present invention are known in the art.

What is claimed is:

1. A training method for a remote sensing landslide object detection model, comprising the following steps:
S1, constructing a data set to store landslide samples {(a visible light image, an auxiliary image); (a mask image, a bounding box)}, wherein the auxiliary image is a grayscale image of an associated attribute feature; both the visible light image and the grayscale image are shooting images of a detection area; the mask image is used to annotate a landslide area in the visible light image; and the bounding box is used to annotate landslide area in the visible light image;
S2, constructing a knowledge embedding model, wherein the knowledge embedding model comprises an embedding module, an attention feature extraction module, a location encoding module, and a segmentation head that are connected in sequence; and wherein the knowledge embedding model takes the auxiliary image as an input and the mask image as an output;
S3, extracting a first training set {auxiliary image, mask image} from the data set, and training the knowledge embedding model on the first training set until convergence;
S4, extracting the sequentially connected embedding module, the attention feature extraction module, the location encoding module from the knowledge embedding model, and connecting the location coding module to a Mask-Region Convolution Neural Networks (Mask-RCNN) model through a convolution module to form a basic model; wherein input data of the basic model comprises the visible light image and the auxiliary image, and the output is the visible light image annotated with bounding box and mask image; and
S5, training the basic model in the data set {(visible light image, auxiliary image); (mask image, bounding box)} to update the attention feature extraction module, the convolution module and the Mask-RCNN model until the basic model converges; wherein the converged basic model is the remote sensing landslide object detection model.

2. The training method for the remote sensing landslide object detection model according to claim 1, wherein the attribute features comprise one or more of elevation, slope, aspect, plane curvature, profile curvature, vegetation coverage, annual rainfall, flow intensity index and topographic humidity index.

3. The training method for the remote sensing landslide object detection model according to claim 1, wherein the basic model is trained on the data set, and a loss function used in the training process is: a sum of a classification loss, a bounding box regression loss, and a mask segmentation loss.

4. The training method for the remote sensing landslide object detection model according to claim 3, wherein the calculation formula of classification loss Loss_{cls} is:
$${Loss}_{cls} = - {\sum }_{i = I}^{N} {y}_{i} \cdot log ( {p}_{i} )$$
where yᵢ is a real class label, yᵢ=1 denotes that the landslide is detected, yᵢ=0 denotes that no landslide is detected; pᵢ denotes a landslide probability predicted by the basic model; N is a number of classes, the classes comprise landslide and non-landslide.

5. The training method for the remote sensing landslide object detection model according to claim 3, wherein the calculation formula of bounding box regression loss Loss_{box} is:
$${Loss}_{box} = \frac{1}{M} {\sum }_{m = 1}^{M} {\sum }_{n ∈ \{ x , y , {w}^{′} , {h}^{′} \}} SmoothL 1 ( {t}_{mn} - {t}_{mn}^{′} )$$
$$SmoothL 1 ( x ) = \{ \begin{matrix}0.5 {x}^{′2} & if \vert {x}^{′} \vert < 1 \\ \vert {x}^{′} \vert - 0.5 & otherwise\end{matrix}$$
where M is a number of anchor boxes of landslide samples; tₘₙ denotes a basic model prediction value of a regression objective n of an m^{th} landslide sample anchor box, the regression objective comprises an anchor box center coordinate (x, y), an anchor box width w′ and an anchor box height h′, t′ denotes a true value of the regression objective n of the m^{th} landslide sample anchor box; (tₘₙ−t′ₘₙ) denotes an error of tₘₙ and t′ₘₙ; smoothL1 is a choose function; x′ is a referential parameter.

6. The training method for the remote sensing landslide object detection model according to claim 3, wherein the calculation formula of mask segmentation loss Lossₘₐₛₖ is:
$${Loss}_{mask} = - \frac{1}{H \times W} {\sum }_{h = 1}^{H} {\sum }_{w = 1}^{W} [ {y}_{h , w} ln ( {p}_{h , w} ) + ( 1 - {y}_{h , w} ) ln ( 1 - {p}_{h , w} ) ]$$
where His a height of the visible light image, W is a width of the visible light image, y_{h,w} denotes a value of pixel coordinates (h, w) on a corresponding visible light image on the real mask image; p_{h,w} denotes a probability that the value of the pixel coordinate (h, w) on the mask image predicted by the basic model is 1; ln denotes a logarithmic function.

7. The training method for the remote sensing landslide object detection model according to claim 1, wherein the embedding module adopts a query dictionary embedding; the location coding module adopts a rotary coding method, and the attention feature extraction module adopts a convolutional block attention module (CBAM).

8. A remote sensing landslide object detection method using the training method for the remote sensing landslide object detection model according to claim 1, comprising:
St1, obtaining the remote sensing landslide object detection model by the method of claim 1; acquiring the visible light image and the auxiliary image of the detection area; and
St2, inputting the visible light image and the auxiliary image into the remote sensing landslide object detection model, wherein the remote sensing landslide object detection model outputs the visible light image that are annotated with the bounding box and the mask image.

9. A remote sensing landslide object detection system, wherein the system comprises an unmanned aerial vehicle (UAV), a memory, and a processor, wherein the UAV is used to collect visible light images and auxiliary images; the memory stores a computer program, the processor is connected to the memory and the UAV, and the processor is configured to execute the computer program to implement the remote sensing landslide object detection method according to claim 8.

10. A readable medium, wherein the readable medium stores a computer program, and when the computer program is executed, the computer program is used to implement the remote sensing landslide object detection method according to any one claim 8.
